(19) United States
(12) Patent Application Publication
(10) Pub. No.: US 2009/0309840 A1
(43) Pub. Date: Dec. 17, 2009

(54) WIRELESS TRANSMITTER INSTALLED AT TOUCH SCREEN FOR BI-DIRECTIONAL SIGNAL TRANSMISSION, AND WIRELESS TRANSMISSION MODULE INSTALLED BETWEEN TOUCH SCREEN AND COMPUTER SYSTEM

(75) Inventor: Hung-Huei YU, Taipei (TW)

Correspondence Address: Muncy, Geissler, Olds & Lowe, PLLC, P.O. BOX 1364, FAIRFAX, VA, 22038-1364, US

(73) Assignee: SHUTTLE INC.

(21) Appl. No.: 12/139,908

(22) Filed: Jun. 16, 2008

(51) Int. Cl. G06F 3/041

(52) U.S. Cl. 345/173

(57) ABSTRACT

In a wireless transmitter installed in a touch screen for bi-directional signal transmissions, the touch screen includes an image driving unit for receiving an image signal and converting the image signal into an image display signal and a signal control unit for generating a touch control instruction signal, and the wireless transmitter includes a signal receiving portion coupled to the image driving unit and a signal output portion coupled to the signal control unit, and the signal output portion and the signal receiving portion are coupled to a signal transmitter, such that the image signal and the touch control instruction signal perform bi-directional wireless signal transmissions by the signal transmitter and an external electronic device through the signal receiving portion and the signal output portion.

### FIELD OF THE INVENTION

The present invention relates to a wireless transmitter, and more particularly to a wireless transmitter installed at a touch screen for bi-directional signal transmissions.

### BACKGROUND OF THE INVENTION

Computer systems including industrial computers, personal computers and notebook computer are used extensively for computing and storing digital data. In general, a computer system usually includes a display device provided for users to read information and an input device provided for users to enter instructions or signals, in addition to the functions of computing and storing data. For example, the display device of a personal computer can be a flat panel display, and the input device can be a keyboard or a mouse. Although this type of input device is commonly used by the general public, yet the instruction for performing an indirect move or select inputted by this type of input device is displayed on a display device, and users must be familiar with the operation of the input device to improve the operating speed or efficiency, and thus giving rise to the fast development of the touch screen technology capable of directly operating the display device.

A general touch screen is divided mainly into a resistance touch screen and a capacitance touch screen, and the resistance touch screen is most commonly used. The resistance touch screen is primarily formed by coating a soft plastic film (such as a PET film) of an indium tin oxide (ITO) layer and glass separated by a space dot. If the upper-layer soft plastic film is pressed, the ITO layer on the soft plastic film and the ITO layer on the glass will be contacted and electrically conducted with each other to generate an electric signal, and the electric signal is transmitted to a controller for computing and displaying the coordinates of a pressing point on the touch screen. A traditional computer system installed with a touch screen relies on a transmission line, a physical port, and a touch screen installed directly in the computer system for transmitting signals between the touch screen and the computer system as disclosed in U.S. Pat. No. 7,327,353 and U.S. Pat. Application No. 20060250975. In other words, users must be situated next to a computer system for entering signals through a touch screen.

As electronic products tend to be developed with a thin and light design, touch screens are used gradually in portable electronic products such as personal digital assistants (PDA), digital frames, and mobile phones, etc. Although the foregoing portable electronic products installed with touch screens provide convenient applications to users and also serve as input devices for the electronic products, the prior art is still restricted by the transmission line for controlling and operating the computer system through the touch screen. Users cannot control instructions or input signals to the computer system according to the users' using habits or preferences, and the transmission lines connected between the touch screen and the computer system result in a messy space. In recent years, wireless communications are applied extensively in the foregoing portable electronic products, but simply used for transmitting data packets in a single direction, and cannot be used for the bi-directional transmission function for transmitting data packets and controlling directive signals.

### SUMMARY OF THE INVENTION

In view of the foregoing shortcomings of the prior art, the primary objective of the present invention is to provide a single wireless communication module having a bi-directional signal transmission function.

To achieve the foregoing objective, the present invention provides a wireless transmitter installed at a touch screen for bi-directional signal transmissions, and the touch screen comprises an image driving unit for receiving an image signal and converting the image signal into an image display signal, and a signal control unit for generating a touch control instruction signal. The wireless transmitter includes a signal output portion coupled to the image driving unit, and a signal receiving portion coupled to the signal control unit, and the signal output portion and the signal receiving portion are coupled to a signal transmitter, such that the image signal and the touch control instruction signal can perform bi-directional wireless signal transmissions by the signal transmitter and an external electronic device through the signal receiving portion and the signal output portion. The electronic device can be a computer system or a portable electronic product, and the electronic device includes another wireless transmitter having corresponding communications with the wireless transmitter.

Another objective of the present invention is to provide a bi-directional signal transmission for transmitting data packets between a touch screen and a computer system and controlling an instruction signal.

To achieve the foregoing objective, the present invention provides a wireless transmission module installed between a touch screen and a computer system, wherein a touch screen receives an image signal in the form of a wireless transmission signal outputted from a computer system and the touch screen outputs a user's touch control instruction signal to the computer system. The invention comprises a first wireless transmitter installed in the touch screen and a second wireless transmitter installed in the computer system. The first wireless transmitter includes a first signal output portion and a first signal receiving portion, and the first signal output portion and the first signal receiving portion are coupled to the first signal transmitter. The second wireless transmitter includes a second signal output portion and a second signal receiving portion, and the second signal output portion and the second signal receiving portion are coupled to the second signal transmitter. The image signal of the computer system is transmitted from the second signal output portion to the first signal receiving portion and displayed on the touch screen, and a touch control instruction signal generated by the touch screen is transmitted to the second signal receiving portion of the computer system through the first signal output portion to control a data processing unit installed in the computer system.

With the signal input portion and the signal receiving portion of the wireless transmitter, the touch screen of the computer system in accordance with the invention can achieve the bi-directional wireless signal transmissions for transmitting data packets and operating instruction signals by first and second wireless transmitters of a single wireless transmission module.

### BRIEF DESCRIPTION OF THE DRAWINGS

FIG. 1 is a structural block diagram of a wireless transmitter installed at a touch screen for bi-directional signal transmissions in accordance with a preferred embodiment of the present invention; and

FIG. 2 is a structural block diagram of a wireless transmission module installed between a touch screen and a computer system in accordance with a preferred embodiment of the present invention.

### DETAILED DESCRIPTION OF THE PREFERRED EMBODIMENTS

The technical contents of the present invention will now be described in more detail hereinafter with reference to the accompanying drawings that show various embodiments of the invention.

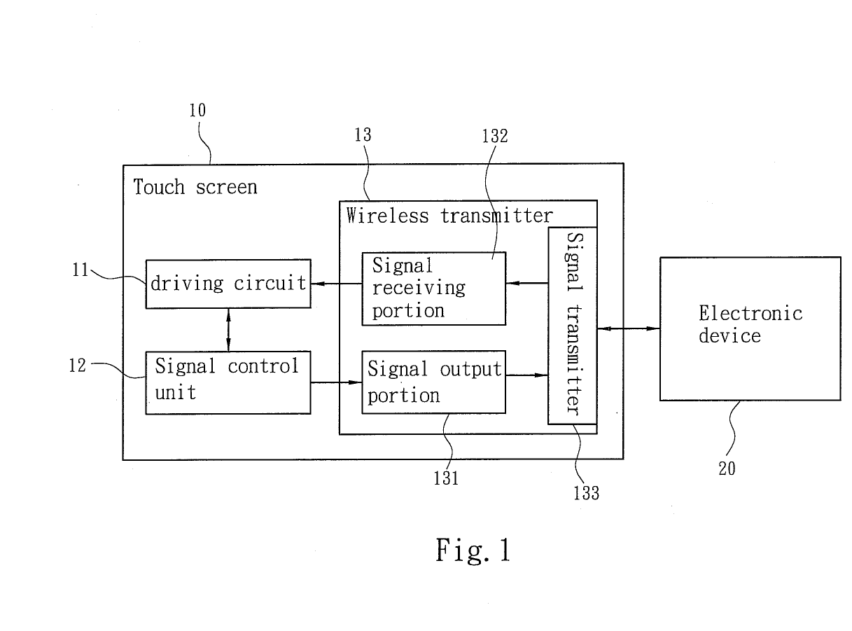

With reference to FIG. 1 for a structural block diagram of a wireless transmitter installed at a touch screen for bi-directional signal transmissions in accordance with a preferred embodiment of the present invention, the touch screen 10 comprises an image driving unit 11 for receiving an image signal and converting the image signal into an image display signal, a signal control unit 12 for generating a touch control instruction signal, and a wireless transmitter 13. The wireless transmitter 13 includes a signal receiving portion 132 coupled to the image driving unit 11, and a signal output portion 131 coupled to the signal control unit 12, and the signal output portion 131 and the signal receiving portion 132 are coupled to a signal transmitter 133, such that the image signal and the touch control instruction signal can perform bi-directional wireless signal transmissions by the signal transmitter 133 and an external electronic device 20 through the signal receiving portion 132 and the signal output portion 131.

The electronic device 20 is a computer system or a portable electronic product and includes another wireless transmitter (not shown in the figure) having corresponding communications with the wireless transmitter 13. The signal transmitter 133 transmits signals selectively by a wireless universal serial bus (WUSB) module, a Bluetooth communication module, an infrared (IR) communication module and a radio frequency (RF) communication module.

From the description above, the touch screen 10 of the invention receives an image signal from an external electronic device 20 to display an image and also transmits a touch control instruction signal generated by the signal control unit 12 of the touch screen 10 to the electronic device 20 for controlling and operating the electronic device 20 to achieve the bi-directional wireless signal transmissions.

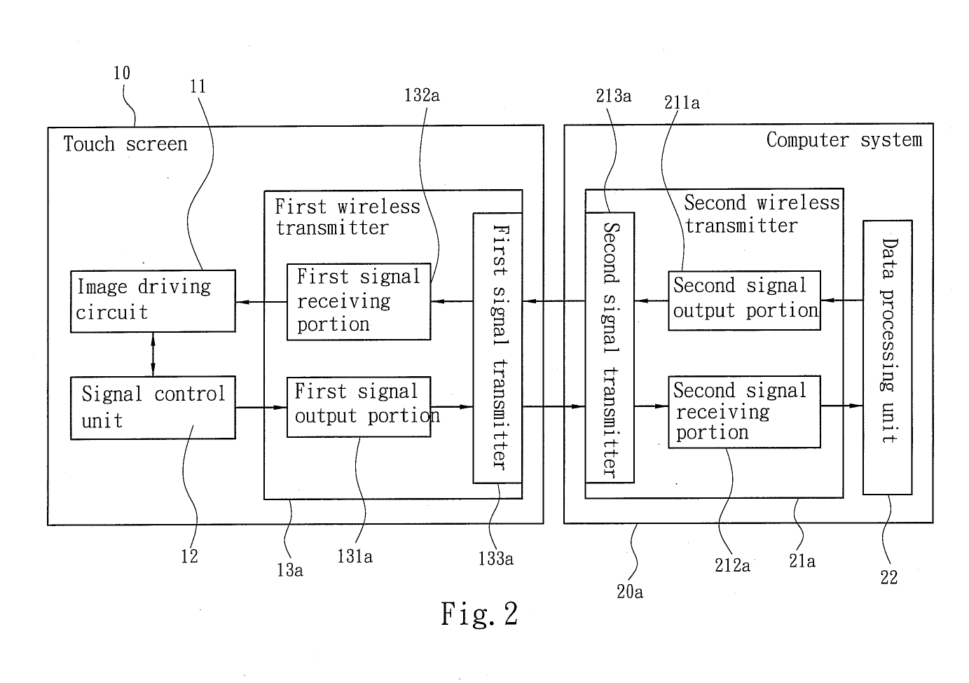

The present invention further discloses a wireless transmission module installed between a touch screen and a computer system as shown in FIG. 2. In the wireless transmission module, a touch screen 10 receives an image signal in the form of a wireless transmission signal outputted from a computer system 20a, and the touch screen 10 outputs an user's touch control instruction signal to the computer system 20a. The touch screen 10 includes an image driving unit 11 for receiving the image signal and converting the image signal into an image display signal, and a signal control unit 12 for generating a touch control instruction signal according to the user's touch operation.

The wireless transmission module includes a first wireless transmitter 13a installed at the touch screen 10 and a second wireless transmitter 21a installed at the computer system 20a. The first wireless transmitter 13a includes a first signal output portion 131a and a first signal receiving portion 132a, and the first signal output portion 131a and the first signal receiving portion 132a are coupled to the first signal transmitter 133a. The second wireless transmitter 21a includes a second signal output portion 211a and a second signal receiving portion 212a, and the second signal output portion 211a and the second signal receiving portion 212a are coupled to the second signal transmitter 213a. The image signal of the computer system 20a is transmitted from the second signal output portion 211a to the first signal receiving portion 132a through the connection of the second signal transmitter 213a and the first signal transmitter 133a and displayed on the touch screen 10. Similarly, the touch control instruction signal generated by the signal control unit 12 of the touch screen 10 is transmitted from the first signal output portion 131a to second signal receiving portion 212a of the computer system 20a through the second signal transmitter 213a and the first signal transmitter 133a to control a data processing unit 22 installed in the computer system 20a.

The first and second signal transmitters 133a, 213a transmit signals selectively by a wireless USB (WUSB) module, a Bluetooth communication module, an infrared communication module and a radio frequency communication module.

In summation of the description above, the invention achieves the bi-directional wireless signal transmissions of a single wireless transmitter installed in a touch screen with an external electronic device. The invention also achieves the bi-directional wireless signal transmissions for transmitting data packets and operating instruction signals between a touch screen and a computer system by the first and second wireless transmitters of a single wireless transmission module. Users can read the received image or data signal from the touch screen or directly operate the touch screen to perform a wireless operation or control of the electronic device. The invention waives the limitation of relying on the transmission lines and herein enhances the performance over the conventional structure and further complies with the patent application lo requirements and is duly filed for patent application.

While the invention has been described by means of specific embodiments, numerous modifications and variations could be made thereto by those skilled in the art without departing from the scope and spirit of the invention set forth in the claims.

What is claimed is:

1. A wireless transmitter installed at a touch screen for bi-directional signal transmissions, and the touch screen having an image driving unit for receiving an image signal and converting the image signal into an image display signal, and a signal control unit for generating a touch control instruction signal, characterized in that:
the wireless transmitter includes a signal receiving portion coupled to the image driving unit and a signal output portion coupled to the signal control unit, and the signal output portion and the signal receiving portion are coupled to a signal transmitter, such that the image signal and the touch control instruction signal perform bi-directional wireless signal transmissions by the signal transmitter and an external electronic device through the signal receiving portion and the signal output portion.

2. The wireless transmitter installed at a touch screen for bi-directional signal transmissions of claim 1, wherein the electronic device is a computer system.

3. The wireless transmitter installed at a touch screen for bi-directional signal transmissions of claim 1, wherein the electronic device is a portable electronic product.

4. The wireless transmitter installed at a touch screen for bi-directional signal transmissions of claim 1, wherein the electronic device comprises another wireless transmitter for communicating with the wireless transmitter correspondingly.

5. The wireless transmitter installed at a touch screen for bi-directional signal transmissions of claim 1, wherein the signal transmitter is a wireless USB module.

6. The wireless transmitter installed at a touch screen for bi-directional signal transmissions of claim 1, wherein the signal transmitter is a Bluetooth communication module.

7. The wireless transmitter installed at a touch screen for bi-directional signal transmissions of claim 1, wherein the signal transmitter is an infrared communication module.

8. The wireless transmitter installed at a touch screen for bi-directional signal transmissions of claim 1, wherein the signal transmitter is a radio frequency communication module.

9. A wireless transmission module installed between a touch screen and a computer system, and the touch screen receiving an image signal in a form of a wireless transmission signal outputted from the computer system, and driving the touch screen to display an user's touch control instruction signal to the computer system, and the wireless transmission module comprising:
a first wireless transmitter, installed at the touch screen, and having a first signal output portion and a first signal receiving portion, and the first signal output portion and the first signal receiving portion being coupled to the first signal transmitter;
a second wireless transmitter, installed at the computer system, and having a second signal output portion and a second signal receiving portion, and the second signal output portion and the second signal receiving portion being coupled to the second signal transmitter;
wherein an image signal of the computer system is transmitted from the second signal output portion to the first signal receiving portion and displayed on the touch screen, and a touch control instruction signal generated by the touch screen is transmitted to a second signal receiving portion of the computer system through the first signal output portion for controlling a data processing unit installed in the computer system, so as to perform bi-directional wireless signal transmissions between the touch screen and the computer system by the first and second wireless transmitters of a single wireless transmission module.

10. The wireless transmission module installed between a touch screen and a computer system of claim 9, wherein the first and second signal transmitters are wireless USB modules.

11. The wireless transmission module installed between a touch screen and a computer system of claim 9, wherein the first and second signal transmitters are Bluetooth communication modules.

12. The wireless transmission module installed between a touch screen and a computer system of claim 9, wherein the first and second signal transmitters are infrared communication modules.

13. The wireless transmission module installed between a touch screen and a computer system of claim 9, wherein the first and second signal transmitters are radio frequency communication modules.
